(19) United States
(12) Patent Application Publication
(10) Pub. No.: US 2025/0156099 A1
(43) Pub. Date: May 15, 2025

(54) OPTIMIZATION FOR UNMAP BACKLOG OPERATIONS IN MEMORY SYSTEM

(71) Applicant: Micron Technology, Inc., Boise, ID (US)

(72) Inventors: Chunyu Sheng, Shanghai (CN); Huachen Li, Shanghai (CN); Xiaolai Zhu, Shanghai (CN); Xiao Wang, Shanghai (CN); Wenjun Wu, Shanghai (CN)

(21) Appl. No.: 19/022,976

(22) Filed: Jan. 15, 2025

Related U.S. Application Data
(60) Provisional application No. 62/621,517, filed on Jan. 24, 2018.

(51) Int. Cl. G06F 3/06

(52) U.S. Cl. CPC G06F 3/0644; G06F 3/0604; G06F 3/0673

(57) ABSTRACT

Methods, systems, and devices for optimization for unmap backlog operations in a memory system are described. A memory system may perform multiple iterations of an unmap process for a set of data in an unmap backlog. Each iteration may include storing a change log that indicates entries in a second physical pointer that have changed according to the unmap process and storing a page validity change log according to the second physical pointer. The memory system may include circuitry configured to merge the physical pointers to generate the page validity change logs. The circuitry may merge the page validity change logs with one or more page validity tables (PVTs) to update the one or more PVTs. After completing the iterations, the memory system may flush the one or more updated PVTs from a first memory device to a second memory device of the memory system.

### CROSS REFERENCE

The present application for patent claims priority to U.S. Patent Application No. 63/621,517 by Sheng et al., entitled “OPTIMIZATION FOR UNMAP BACKLOG OPERATIONS IN MEMORY SYSTEM,” filed Jan. 16, 2024, which is assigned to the assignee hereof, and which is expressly incorporated by reference in its entirety herein.

### TECHNICAL FIELD

The following relates to one or more systems for memory, including optimization for unmap backlog operations in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states after disconnection from an external power source.

### BRIEF DESCRIPTION OF THE DRAWINGS

FIG. 1 shows an example of a system that supports optimization for unmap backlog operations in a memory system in accordance with examples as disclosed herein.

FIG. 2 shows an example of a system that supports optimization for unmap backlog operations in a memory system in accordance with examples as disclosed herein.

FIG. 3 shows an example of an unmap backlog process that supports optimization for unmap backlog operations in a memory system in accordance with examples as disclosed herein.

FIG. 4 shows an example of a flow diagram that supports optimization for unmap backlog operations in a memory system in accordance with examples as disclosed herein.

FIG. 5 shows an example of a flow diagram that supports optimization for unmap backlog operations in a memory system in accordance with examples as disclosed herein.

FIG. 6 shows a block diagram of a memory system that supports optimization for unmap backlog operations in a memory system in accordance with examples as disclosed herein.

FIGS. 7 through 9 show flowcharts illustrating a method or methods that support optimization for unmap backlog operations in a memory system in accordance with examples as disclosed herein.

### DETAILED DESCRIPTION

A memory system may receive, for example from a host device, one or more unmap commands. An unmap command may indicate that data at a logical address (or range of logical addresses) will no longer be used by (e.g., has been invalidated by), for example, the host device. The memory system may perform an unmap operation based at least in part on or in response to the unmap command to move the data from a mapped address space to an unmapped address space. That is, the memory system may update a page validity table (PVT) to indicate that the data stored at physical addresses corresponding to the unmapped logical address(es) is not valid (e.g., is no longer valid). The memory system may perform the unmap operation in chunks, and the memory system may store data (e.g., or a pointer to or indication of the data) indicated via the unmap command in an unmap backlog until the corresponding data has successfully been unmapped. The memory system may perform an unmap backlog process to clear the unmap backlog (e.g., complete remaining unmap operations). In some cases, the unmap backlog process may include loading, from a not-AND (NAND) memory to a local system memory, and subsequently flushing back to the NAND memory, two physical pointer tables (PPTs) to determine physical addresses to which the logical address(es) indicated via the unmap command are mapped. Additionally, or alternatively, the unmap backlog process may include loading, updating, and flushing PVT change logs multiple times. Such techniques may utilize relatively large amounts of processing resources and increase latency, in some cases.

In accordance with techniques described herein, a memory system may support a relatively efficient unmap backlog process to clear and/or otherwise reduce an unmap backlog at the memory system. The memory system as described herein may update a second-level PPT with changes as the unmap operations are executed. That is, instead of updating third-level PPTs, which may map logical addresses directly to physical addresses, the memory system may indicate changes in the second-level PPT to reduce overhead. Each entry in the second-level PPT may be associated with a page of, for example, two or more entries in the third-level PPT. The memory system may flush the second-level PPTs back to memory, such as NAND memory. instead of the third-level PPTs to reduce processing and latency. Additionally, or alternatively, the memory system may reduce processing and latency by caching change logs that indicate changes to the second-level PPTs as well as corresponding PVTs until loops (e.g., all loops) of the unmap backlog are complete, at which time the memory system may merge and flush the change logs back to the memory, such as the NAND memory. In some examples, the generating and merging of change logs associated with the PPTs and PVTs may be facilitated by circuitry or other hardware associated with the memory system, which may accelerate the process and further improve efficiency.

In addition to applicability in memory systems as described herein, techniques for optimization for unmap backlog operations in a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing an amount of data in an unmap backlog relatively quickly, which may decrease processing, improve response times, improve storage capacity, or otherwise improve user experience, among other benefits.

In addition to applicability in memory systems described herein, techniques for optimization for unmap backlog operations in a memory system may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by reducing an amount of data in an unmap backlog relatively quickly, and may mitigate unauthorized access to data (e.g., previously deleted or invalidated data) or other information, incur lower latency costs (e.g., by implementing at least some of the unmap processes using hardware), among other benefits.

Features of the disclosure are illustrated and described in the context of systems, devices, and circuits. Features of the disclosure are further illustrated and described in the context of an unmap backlog process flow, flow diagrams, and flowcharts.

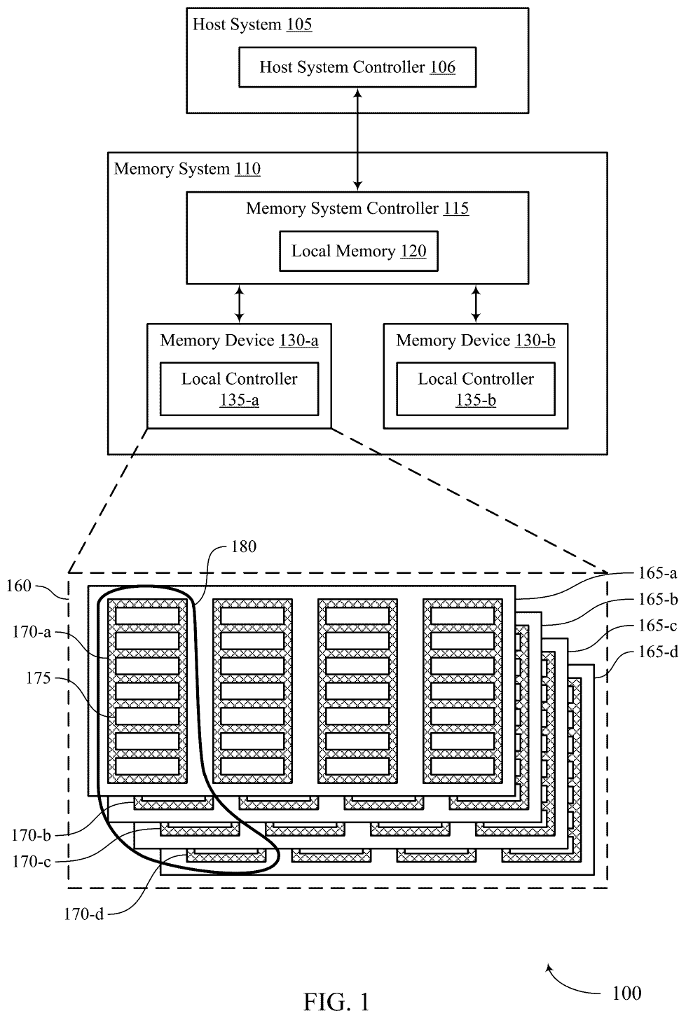

FIG. 1 shows an example of a system 100 that supports optimization for unmap backlog operations in a memory system in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND memory device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. For example, a page validity table (PVT) may be maintained that indicates whether the data is valid or invalid (e.g., at a page level of granularity). Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased. The L2P mapping tables may represent examples of PPTs and/or PVTs as described herein.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support optimization for unmap backlog operations in a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples described herein, the memory system 110 may perform one or more unmap operations to move data from a mapped address space to an unmapped address space in response to an unmap command. The memory system 110 may maintain an unmap backlog that may indicate data that has yet to be moved and/or unmapped. Techniques described herein provide for the memory system 110 to efficiently clear or otherwise reduce an amount of data in the unmap backlog.

The memory system 110 as described herein may update a second-level PPT with changes as the unmap operations are executed. That is, instead of updating third-level PPTs, which may map logical addresses directly to physical addresses, the memory system 110 may indicate changes in the second-level PPT to reduce overhead. The PPTs may also be referred to as L2P tables, in some examples. Each entry in the second-level PPT may be associated with a page of two or more entries in the third-level PPT. The memory system 110 may flush the second-level PPTs back to a NAND memory instead of the third-level PPTs to reduce processing and latency. Additionally, or alternatively, the memory system 110 may reduce processing and latency by caching change logs that indicate changes to the second-level PPTs as well as corresponding PVTs until all loops of the unmap backlog are complete, at which time the memory system 110 may merge and flush the change logs back to the NAND memory. In some examples, the generating and merging of change logs associated with the PPTs and PVTs may be facilitated by circuitry or other hardware associated with the memory system 110, which may accelerate the process and further improve efficiency.

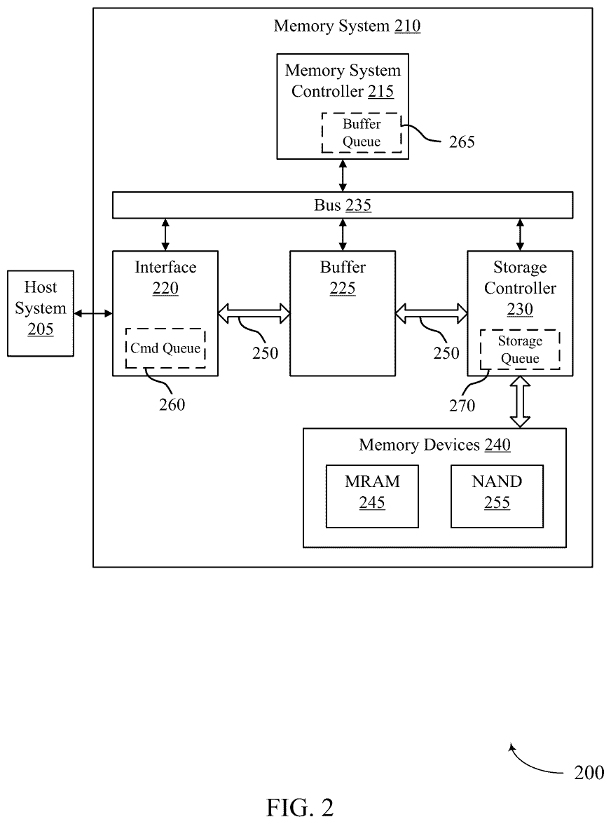

FIG. 2 shows an example of a system 200 that supports optimization for unmap backlog operations in a memory system in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received according to the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) after the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

A memory system 210 (e.g., memory system controller 215) may execute a set of commands received from host system 205 (e.g., from a host system controller of host system 205). The memory system 210 may store the received set of commands in a queue. Further, the memory system 210 may execute the set of commands stored in the queue in the order with which the set of commands were received from the host system 205. In some examples, the memory system 210 may not execute a next command in the queue until a current command has been fully executed—e.g., the commands may be executed on a one-by-one basis and in a first-in-first out order.

The set of commands may include read commands, write commands, unmap commands, memory management commands, etc. Unmap commands may be sent by host system 205 to indicate that data at a logical address (or range of logical addresses) will no longer be used by (e.g., has been invalidated by) the host system 205. In response to receiving an unmap command, the memory system 210 may update a physical validity table to indicate that the data stored at physical addresses corresponding to the unmapped logical address(es) are no longer valid. Accordingly, the memory system 210 may erase and reset the memory cells to an initial state (e.g., to store all 1s) at the unmapped logical address(es) during a garbage collection operation. The unmap command may thereby cause a mapped LBA to transition from a mapped state to a deallocated state (e.g., to move data from a mapped address space to an unmapped address space).

In some examples, the memory system 210 may include one or more different types of memory devices 240. For example, the memory system 210 may include a NAND memory device 255, an MRAM device 245, some other type of memory device, or any combination thereof. In some examples, the memory system 210 may store a multi-level PPT. The MRAM device 245 may store a portion of the multi-level PPT that is frequency used, has been recently used, is predicted to be used, and the like. The MRAM device 245 may, in some examples, represent an example of any type of RAM device (e.g., SRAM, or some other type of RAM). The MRAM device 245 may include volatile memory cells for storing data that can operate without being refreshed.

In some examples, the MRAM device 245 may include a buffer (e.g., a change log buffer) that may be configured to store logical-to-physical mappings for recently performed access operations (e.g., write operations, read operations, unmap operations, erase operations). For example, after receiving a write command associated with a logic address, controller 215 may write data associated with the command to a physical address. And controller 215 may store the mapping between the logical address and the physical address in the change log buffer. In some examples, the logical-to-physical mappings include information that is the same as (or similar to) the information included in PPT3 entries.

By storing the mapping in the change log buffer at the MRAM device 245 (e.g., instead of writing the mapping to the PPT at NAND memory device 255), write operations to a portion of NAND memory device 255 that include the PPT table may be delayed or reduced (e.g., if the controller executes multiple memory operations referencing the mappings stored in the change log buffer). In some examples, change log buffer may be implemented in the MRAM device 245. For example, a set of memory cells in MRAM device 245 may be allocated to change log buffer. Change log buffer may include a quantity of entries (e.g., 4k entries, 8k entries).

The memory system controller 215 (e.g., or a host system controller 106 as described with reference to FIG. 1) may be configured to access data stored in NAND memory device 255 in accordance with commands received from a host system. In some examples, to access the correct physical address in the NAND memory device 255 for a received command, the controller 215 may consult the portion of the PPT stored in the MRAM device 245. If the portion of the PPT stored in the MRAM device 245 does not include the relevant logical-to-physical mapping, the controller 215 may load a relevant portion of the PPT into the MRAM device 245 that does include the relevant logical-to-physical mapping. In some examples, the controller 215 may consult the logical-to-physical mappings stored in change log buffer to identify the correct physical address in the NAND memory device 255.

After performing an access operation, the memory system controller 215 may store, in the change log buffer, a logical-to-physical mapping that indicates a mapping between the logical address of the corresponding write command and the physical address used to store data associated with the corresponding access command.

The NAND memory device 255 may be an example of memory device 130-a of FIG. 1. As described herein, the NAND memory device 255 may be used to store data for applications run at a host system and a PPT. The PPT at the NAND memory device 255 may include logical-to-physical mappings for all of the logical addresses managed by memory system 210. In some examples, PPT compression techniques may be used to decrease a size of the PPT stored at the NAND memory device 255, to decrease an amount of information exchanged to transfer portions of the PPT to and from the MRAM device 245, or both. As described herein, the PPT may be a multi-level table. For example, the PPT may include a PPT1, a PPT2, and a PPT3.

The PPT1 may include one or more PPT1 pages. Each entry in a PPT1 page may point to a PPT2 page of the PPT2. For example, a first entry in the PPT1 may point to a first PPT2 page, a second entry in the PPT1 may point to a second PPT2 page, and so on. The PPT2 may include multiple PPT2 pages. Each entry in a PPT2 page may point to a PPT3 page of the PPT3. For example, a first entry in the PPT2 may point to a first PPT3 page, a second entry in the PPT2 may point to a second PPT3 page, and so on.

The PPT3 may include multiple PPT3 pages. Each entry in a PPT3 page may point to a physical page of physical resources. For example, a first entry in the PPT3 may point to a first physical page, a second entry in the PPT3 may point to a second physical page, and so on. In some examples, each entry in the PPT3 may include a direct logical-to-physical mapping between individual logical addresses and individual physical addresses.

In some examples, the memory system controller 215 or other component (e.g., firmware, hardware, or a combination) within the memory system 210 may manage entries in the change log buffer. For example, the change log buffer may be maintained in a sorted order. In some examples, instead of the memory system controller 215 writing logical-to-physical mappings directly in the change log buffer, the memory system controller 215 may provide logical-to-physical mappings to a change log manager (e.g., firmware or hardware, or a combination), and the change log manager may write the logical-to-physical mappings to the change log buffer.

In some examples, a position for storing a logical-to-physical mappings in the change log buffer may be selected according to a logical address of a logical-to-physical mapping to be stored and logical addresses of logical-to-physical mappings currently stored in the change log buffer. For example, the change log buffer may identify the logical addresses of the currently stored logical-to-physical mappings and store the logical-to-physical mapping at a position that is between a stored logical-to-physical mapping having a lower logical address and a stored logical-to-physical mapping having a higher logical address than the logical address of the logical-to-physical mapping to be stored. Additionally, or alternatively, the logical-to-physical mapping may be stored at an end of change log buffer. An operation for restoring the entries of the change log buffer may be performed after writing the logical-to-physical mapping at the end of change log buffer so that the logical-to-physical mappings are arranged in a numerical order (e.g., an ascending order), where the numerical order may be according to the logical addresses of the logical-to-physical mappings.

In some examples described herein, the memory system 210 may perform one or more unmap operations to move data from a mapped address space to an unmapped address space in response to an unmap command. The memory system 210 may receive an unmap command from the host system 205 and may parse the command (e.g., using firmware). A portion of the unmap command may be processed at a first time (e.g., relatively quickly), and other data indicated via the unmap command may be stored to be processed in the future. The memory system 210 may store the other data in an unmap backlog that may be maintained at one of the memory devices 240 (e.g., the MRAM device 245). The unmap backlog may indicate data that has yet to be moved and/or unmapped. Techniques described herein provide for the memory system 210 to efficiently clear or otherwise reduce an amount of data in the unmap backlog to improve unmap performance. For example, the memory system 210 may reduce an amount of data that is loaded from the NAND memory device 255 to the MRAM device 245, and flushed back to the NAND memory device 255 during the unmap backlog process to reduce processing time and resources.

The memory system 210 as described herein may update a second-level PPT (e.g., PPT2) change log with changes as the unmap operations are executed. That is, instead of updating third-level PPT change logs (e.g., the PPT3), which may map logical addresses directly to physical addresses, the memory system 210 may indicate changes in the second-level PPT to reduce overhead. The memory system 210 may flush the updated second-level PPTs, instead of the third-level PPTs, from the MRAM device 245 to the NAND memory device 255 to reduce processing and latency. Additionally, or alternatively, the memory system 210 may reduce processing and latency by caching change logs (e.g., in the change log buffer at the MRAM device 245) that indicate the changes to the second-level PPTs as well as corresponding PVTs until all loops of the unmap backlog are complete, at which time the memory system 210 may merge and flush the change logs back to the NAND memory device 255. In some examples, the generating and merging of change logs associated with the PPTs and PVTs may be facilitated by circuitry or other hardware associated with the memory system 210, which may accelerate the process and further improve efficiency.

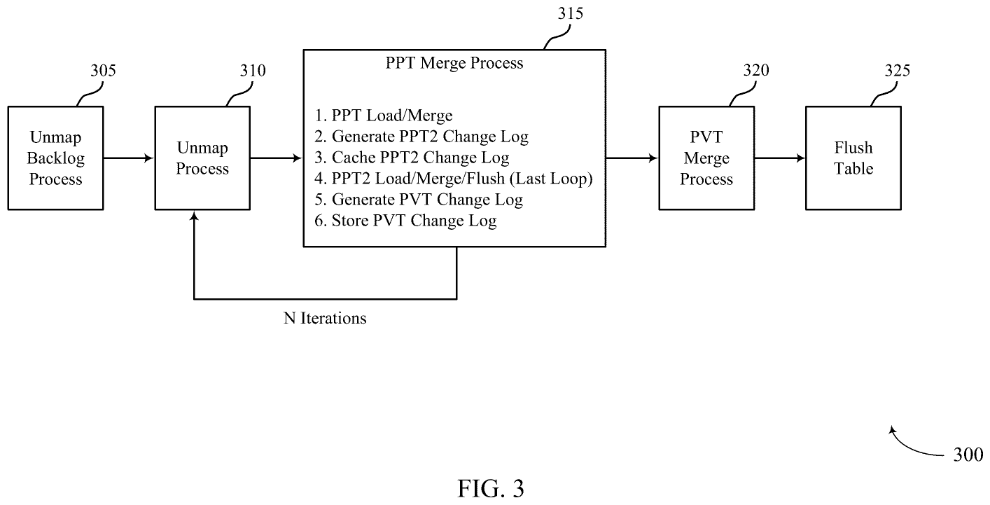

FIG. 3 shows an example of an unmap backlog process 300 that supports optimization for unmap backlog operations in a memory system in accordance with examples as disclosed herein. In some examples, a memory system, which may be an example of the memory systems 110 and 210 as described with reference to FIGS. 1 and 2, may implement aspects of the unmap backlog process 300 using a memory system controller (e.g., a memory system controller 115, 215). The unmap backlog process 300 described herein may provide for the memory system to reduce an amount of data in an unmap backlog while reducing processing and latency as compared with other unmap processes. For ease of reference, the unmap backlog process 300 is described with reference to the memory system 210. For example, aspects of the unmap backlog process 300 may be implemented by one or more controllers, among other components. Additionally or alternatively, aspects of the unmap backlog process 300 may be implemented as instructions stored in one or more memories (e.g., firmware stored in the volatile memory 120 and/or the non-volatile memory 125). For example, the instructions, when executed by one or more controllers (e.g., the interface controller 115), may cause the one or more controllers (or a device or a system) to perform the operations of the unmap backlog process 300. It is to be understood that various aspects of the unmap backlog process 300 may be performed by one or more various components of the memory system, including one or more memory system controllers, one or more memory device controllers, firmware, hardware, or any combination thereof.

Alternative examples of the unmap backlog process 300 may be implemented in which some operations are performed in a different order than described or are not performed at all. In some cases, operations may include features not mentioned below, or additional operations may be added.

At 305, the memory system may initiate the unmap backlog process. The memory system may receive one or more unmap commands, for example, from a host device. The memory system may decode and parse the unmap command(s). The memory system may store data indicated via the unmap command(s) that has not yet been unmapped in an unmap backlog. The unmap backlog may be or include a bitmap, or some other type of data structure, that may be used to store unmap information. In some examples, a unit of the unmap backlog may correspond to a single PPT region (e.g., four megabytes of data, or 1024 LBA). In some examples, a single bit in the unmap backlog may indicate that a corresponding segment of data is unmapped (e.g., a 4 megabyte section of data). The unmap backlog bitmap may be stored in a second memory device of the memory system (e.g., a NAND memory device) and may be loaded from the second memory device to a first memory device (e.g., an MRAM device) during the unmap backlog process. The unmap backlog may be flushed back to the NAND memory device after the unmap backlog process. The unmap backlog may be stored in an open table virtual block, in some examples.

The memory system may initiate the unmap backlog process to unmap data in the unmap backlog (e.g., to reduce or clear the unmap backlog). In some examples, the memory system may initiate the unmap backlog process using one or more timings, such as periodically, randomly, in response to a quantity of data in the unmap backlog exceeding a threshold, other timings, or any combination thereof.

At 310, the memory system may perform the unmap process. As part of the unmap process, the memory system (e.g., firmware at the memory system controller, or some other component) may consume a size of unmap data from the unmap backlog. The size of the unmap data that is retrieved and consumed from the unmap backlog per unmap backlog process may be defined (e.g., predefined or configured at the memory system), in some examples. The size of the data may correspond to a quantity of blocks of data, or some other unit of data size. In some examples, the size of the data may be selected such that the memory system may unmap the data within a threshold time period before performing other access operations (e.g., so that the unmap operation is uninterrupted).

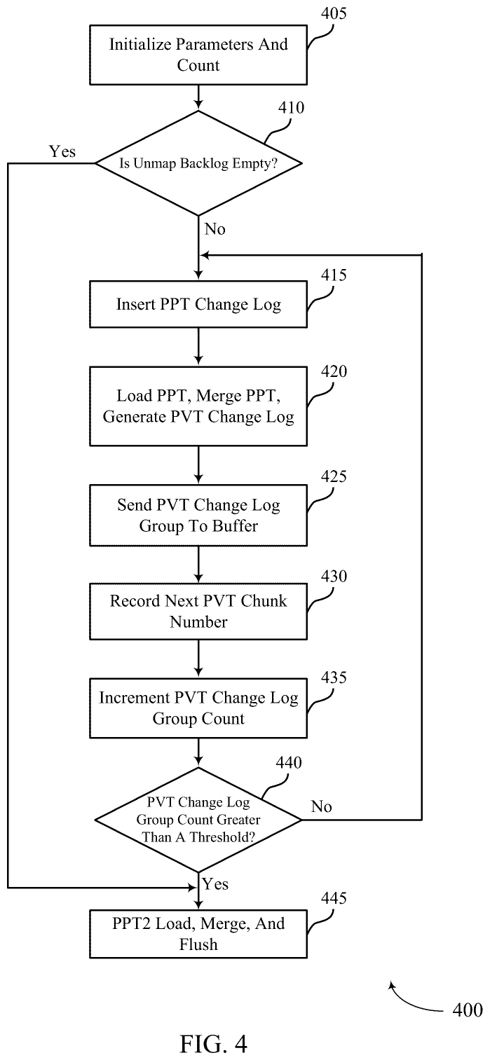

The unmap process may be performed in one or more iterations to produce multiple PVT change logs. As part of each iteration, the memory system may obtain (e.g., identify, retrieve) a first PPT change log. The first PPT change log may be a change log stored at a first memory device of the memory system (e.g., an MRAM device, such as the MRAM device 245 described with reference to FIG. 2). The first PPT change log may include one or more changes to a first PPT in accordance with the unmap process, which may be a level-3 PPT (e.g., PPT3), as described with reference to FIG. 1. In some examples, the unmap backlog may indicate (e.g., correspond to, include) the first PPT change log, as described with reference to FIG. 4.

At 315, for each iteration of the one or more iterations (e.g., N iterations), the memory system may perform a PPT merge process. The PPT merge process may include loading a first PPT (e.g., PPT3) from a second memory device (e.g., a NAND memory device, such as the NAND memory device 255 described with reference to FIG. 2) of the memory system to the first memory device. The first PPT may be merged with the first PPT change log to identify changes to the first PPT. In some cases, the memory system may flush the first PPT back to the second memory device, which may increase processing and overhead per iteration.

However, techniques described herein provide for the memory system to refrain from flushing the first PPT to the second memory device to reduce processing and latency. Instead, at 315, the memory system may generate a second change log that indicates a set of entries in a second PPT (e.g., PPT2) that have changed in response to the unmap process. The second change log may be generated in accordance with the first PPT and corresponding changes. For example, each entry of the second PPT may correspond to (e.g., point to) a page of entries in the first PPT. Thus, the second change log may indicate pages of the first PPT that have changed as part of the unmap process. By recording the unmap information of the first PPT in the second PPT and corresponding second change log, the memory system may reduce latency and processing. For example, the memory system may reduce an amount of data that is flushed to NAND memory, may reduce a granularity at which changed data is indicated and stored, or both, by recording the unmap information at the second PPT level.

The memory system may store the second PPT change log in the first memory device in each iteration until a final iteration of the unmap process. In some examples, the second PPT change log may be cached with memory (e.g., stored in an MRAM cache). By refraining from flushing the second PPT change log back to the first memory device in each iteration, the memory system may reduce processing and latency associated with the unmap operation.

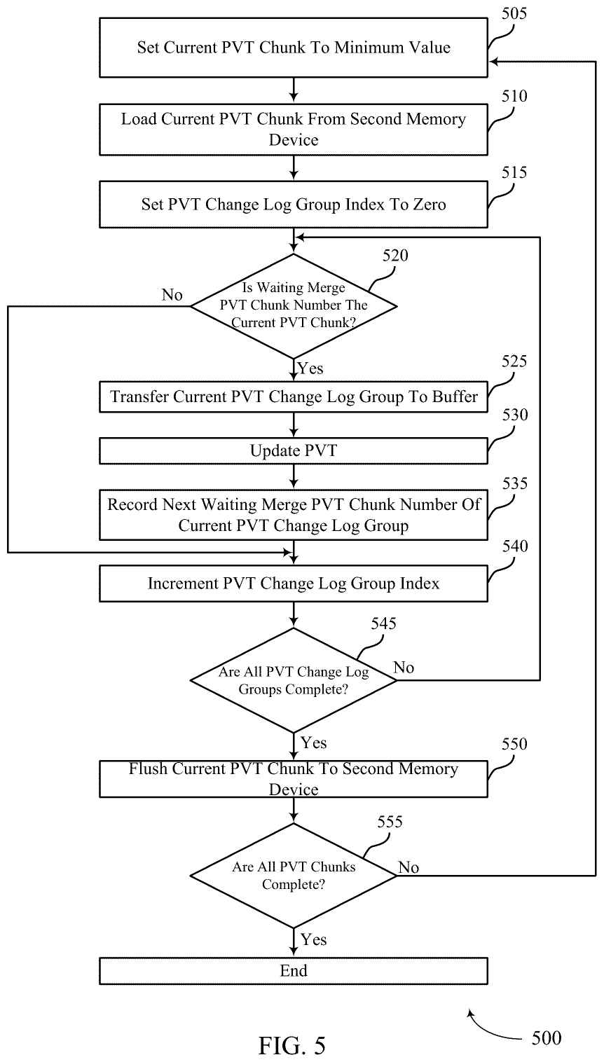

The memory system may generate, in each iteration of the one or more iterations of the unmap process, a respective PVT change log. The memory system may use the second PPT and the second PPT change log to generate the PVT change log. That is, the PVT change log, which may also be referred to as a PVT change log group herein, may be generated by the PPT merge process and may be stored in a buffer at the first memory device (e.g., an MRAM buffer) until a final iteration. Techniques for generating the PVT change log are described in further detail elsewhere herein, including with reference to FIGS. 4 and 5. The memory system may store the PVT change log in the first memory device in each iteration.

The memory system may loop through each iteration of the one or more iterations of the unmap process by performing 310 and 315 a quantity of times (e.g., N times). A quantity of the iterations, N, may in some examples be selected based on or according to a size of the data that the memory system consumes from the unmap backlog per operation. The quantity of iterations may vary in accordance with one or more parameters associated with the memory system. The quantity of iterations may be selected by the memory system controller, by the host device, may be configured for the memory system, may be selected randomly, or any combination thereof. The quantity of iterations may be selected such that the memory system may complete the unmap backlog process before performing other access operations (e.g., without any interruptions, with less than a threshold quantity of interruptions). That is, the memory system may unmap some quantity of data in each unmap backlog process, and the memory system may perform other operations between the unmap backlog processes. In some examples, each iteration may generate a single PVT change log group, and there may be N PVT change log groups generated after the N iterations are complete, as described in further detail elsewhere herein, including with reference to FIGS. 4 and 5.

On an iteration, such as a final iteration, of the one or more iterations of the unmap process, the memory system may load a second-level PPT from the second memory device, merge the second-level PPT (e.g., PPT2) with the second PPT change log, and flush the updated second-level PPT back to the second memory device. Techniques for loading, merging, and flushing the second-level PPT are described in further detail elsewhere herein, including with reference to FIG. 4. By refraining from loading, merging, and flushing the second-level PPT until the final iteration, the memory system may reduce processing and overhead as compared with other unmap operations in which the second-level PPT may be loaded and flushed in each iteration.

At 320, after performing all of the one or more iterations of the unmap backlog process, the memory system may perform a PVT merge process to consume all PVT change log groups that are stored in the buffer at the first memory device. The PVT merge process may merge the one or more change log groups generated during the one or more iterations of the unmap backlog process. For example, the PVT merge process may include loading one or more PVTs from the second memory device to the first memory device, merging the one or more PVTs with the one or more PVT change log groups generated during the unmap backlog iterations, and flushing the updated PVTs back to the second memory device, as described in further detail elsewhere herein, including with reference to FIG. 5.

At 325, the memory system may complete the unmap backlog process, and the memory system may flush the remaining table(s) back to the second memory device. For example, the memory system may flush any system tables, the unmap backlog, or any combination thereof from the first memory device to the second memory device.

In some examples, the merging of the second PPT change logs with the second PPT, the merging of the PVTs, or both may be performed by change log management circuitry of the memory system. For example, the memory system may leverage hardware to accelerate the PPT and PVT merge processes. The memory system (e.g., firmware) may perform the PPT merge process multiple times, and may perform the PVT merge process once to reduce overhead. The hardware may perform the merge processes faster than software, in some examples, as described in further detail elsewhere herein, including with reference to FIGS. 4 and 5.

The memory system described herein may thereby perform the unmap backlog process 300 to reduce an amount of data in an unmap backlog at the memory system. By refraining from flushing a first PPT (e.g., PPT3) back to NAND memory, by reducing a frequency of loading and flushing a second PPT (e.g., PPT2) to and from NAND memory, and by refraining from flushing a PVT until after all iterations of the unmap backlog process, the memory system may reduce overhead, reduce processing resources, reduce latency, and improve the overall unmap backlog process as compared with systems in which the first PPT is flushed to NAND, and the second PPT and corresponding PVT are loaded from and flushed to NAND every iteration.

FIG. 4 shows an example of a flow diagram 400 that supports optimization for unmap backlog operations in a memory system in accordance with examples as disclosed herein. In some examples, a memory system, which may be an example of the memory systems 110 and 210 as described with reference to FIGS. 1 and 2, may implement aspects of the flow diagram 400 using a memory system controller (e.g., a memory system controllers 115 and 215).

For ease of reference, the flow diagram 400 is described with reference to the memory system 210. For example, aspects of the flow diagram 400 may be implemented by one or more controllers, such as an interface controller, among other components. Additionally or alternatively, aspects of the flow diagram 400 may be implemented as instructions stored in one or more memories (e.g., firmware stored in the volatile memory 120 and/or the non-volatile memory 125). For example, the instructions, when executed by one or more controllers (e.g., the interface controller 115), may cause the one or more controllers (or a device or a system) to perform the operations of the flow diagram 400. It is to be understood that various aspects of the flow diagram 400 may be performed by one or more various components of the memory system, including one or more memory system controllers, one or more memory device controllers, firmware, hardware, or any combination thereof.

Alternative examples of the flow diagram 400 may be implemented in which some operations are performed in a different order than described or are not performed at all. In some cases, operations may include features not mentioned below, or additional operations may be added.

The flow diagram 400 may illustrate a method to generate and store (e.g., cache) PVT change logs during the unmap process described with reference to FIG. 3. For example, the memory system may perform the flow diagram 400 in each iteration of the one or more iterations described with reference to FIG. 3 to merge the PPT and generate the PVT change logs.

At 405, one or more parameters and counts are initialized. For example, The memory system (e.g., memory system 110) may initialize a change log group count to zero, which may indicate that the change log group to be generated is a first change log group. The one or more parameters may include one or more operational parameters for a change log management circuitry, a threshold count associated with the unmap backlog process (e.g., N), a threshold size associated with PVT change log groups, one or more other parameters, or any combination thereof.

At 410, it may be determined whether the unmap backlog is empty or not. If the memory system determines that the unmap backlog is empty, the memory system may end the procedure, as there may not be data to unmap. If the memory system determines that the unmap backlog is not empty (e.g., at least some data is included in the unmap backlog), the memory system may continue the process to reduce the unmap backlog, which may represent an example of the unmap backlog process being initiated in FIG. 3, in some examples.

At 415, a PPT change log may be inserted. For example, if the unmap backlog is not empty, the memory system may initiate the unmap backlog process by inserting a PPT change log. The PPT change log may be inserted from the unmap backlog. For example, the PPT change log may indicate changes to one or more entries in a third-level PPT (e.g., PPT3) in response to unmapping data indicated via the unmap backlog. In some examples, inserting the PPT change log may include storing the PPT change log at a change log management circuitry or other hardware configured to perform a PPT merge. In some examples, the unmap backlog may be a bitmap that includes one or more bits set high and remaining bits set low. Each bit may correspond to a range of data (e.g., a four megabyte range of data, or some other size), which may correspond to a respective entry in a PPT change log. If a bit is set high in the unmap backlog, the corresponding PPT change log entry may be changed (e.g., a one kilobyte PPT entry).

At 420, the PPT may be loaded from a second memory device and merged to generate a PVT change log. For example, the memory system may load the PPT from a second memory device (e.g., NAND memory). The memory system may perform a PPT merge to update the PPT by merging the PPT loaded from the second memory device with the PPT change log obtained from the unmap backlog. In some examples, the memory system may provide the PPT loaded from the second memory device to the change log management circuitry with the PPT change log, and the change log management circuitry may perform the merge process, which may be faster than if firmware performs the merge, in some examples, thereby reducing overhead and processing. For example, the change log management circuitry may obtain, from a second memory device configured to store PPTs, the PPT configured to map logical addresses to physical addresses (e.g., a first physical pointer). The change log management circuitry may obtain, from the first memory device, one or more change logs (e.g., the PPT change log) configured to indicate changes to the data in response to the unmap process. The change log management circuitry may apply the change logs to the PPT during the merge process, and the PPT may output a PVT change log configured to indicate one or more pages of the data that have changed in response to the unmap backlog process.

The memory system may refrain from flushing the PPT back to the second memory device after the PPT merge to reduce overhead and processing, as described with reference to FIG. 3. In some examples, the memory system may generate or obtain a second-level PPT change log (e.g., PPT2 change log) according to (e.g., using) the PPT change log, the unmap backlog, the PPT merge, or any combination thereof. The second-level PPT change log may be maintained at the first memory device (e.g., MRAM). In some examples, the change log management circuitry may obtain a second PPT (e.g., PPT2) from the second memory device and may apply the one or more second-level PPT change logs to the second PPT as part of a second PPT merge process. In such cases, the PVT change log may be generated based on the first and second PPT merge processes. Additionally, or alternatively, the second-level PPT may be loaded and merged after the PVTs are generated.

The PPT merge by the change log management circuitry, the firmware, or both, may thereby generate a PVT change log. The PVT change log may be no more than a threshold size (e.g., eight kilobytes, or some other threshold size) that is supported by the memory system. In some examples, each entry in the PVT change log may correspond to a respective entry in the PPT that has changed in response to the unmap backlog process. The memory system may thereby generate a PVT change log of up to the threshold size before completing the PPT merge process for the given iteration. In other words, the memory system may generate a PVT change log that represents changes in up to a threshold amount of data to be unmapped. A PVT change log including the threshold size of data may be referred to as a PVT change log group herein.

At 425, the current PVT change log group may be sent to a buffer. For example, the memory system may initiate the transfer of the generated PVT change log group to a buffer of a first memory device (e.g., an MRAM buffer). In some examples, the change log management circuitry may output the PVT change log group, and the PVT change log group may be transferred from the output of the change log management circuitry. The memory system may send the PVT change log group to the buffer using a direct memory access (DMA) connection, or some other type of connection.

At 430, a next PVT chunk number may be recorded. For example, the memory system may search for and record a next PVT chunk number. The memory system (e.g., firmware at the memory system) may search a next minimum virtual block number that is waiting to be merged with a PVT chunk number of the current PVT change log group. The memory system may record the identified next number with the change log management circuitry or elsewhere in the memory system. At 435, the PVT change log group count may be incremented. For example, the memory system may increment the PVT change log group count by one (e.g., PVT change log group count ++), or to the next identified number, or both.

At 440, after incrementing the PVT change log group count, it may be determined whether the PVT change log group count is greater than a threshold count. If the memory system determines that the PVT change log group count is less than the threshold count, the memory system may continue the iterations of the unmap process by returning to 410 to determine whether the unmap backlog is empty. The memory system may continue to generate PVT change log groups until the unmap backlog is empty, until the PVT change log group count is greater than or equal to the threshold count, or both.

If the memory system determines that the PVT change log group count is greater than or equal to the threshold count, the memory system may exit the PVT generation process. In some examples, the threshold count may correspond to the quantity of iterations, N, of the unmap backlog process, as described with reference to FIG. 3. For example, the memory system may perform up to a threshold quantity of iterations to generate up to the threshold quantity of PVT change log groups.

At 445, if the PVT change log group count is greater than the threshold, or the unmap backlog is empty, or both, a second-level PPT may be loaded from the second memory device. The memory system may load the second-level PPT and may merge the second-level PPT with a second-level PPT change log maintained at the first memory device. In some examples, the CLM may perform the PPT merge process. The second-level PPT may thereby be updated with any changes that occurred due to the unmap process. The memory system may subsequently flush the second-level PPT back to the first memory device after the second-level PPT is updated. The memory system may thereby refrain from flushing the first-level PPT, and may flush the second-level PPT after completion of multiple iterations of the unmap backlot and PVT generation process, which may reduce overhead and processing, as described in further detail elsewhere herein, including with reference to FIG. 3.

The memory system may thereby generate one or more change log groups as part of an unmap backlog process. By storing the change log groups in a local buffer (e.g., an MRAM buffer) during each iteration, the memory system may reduce overhead and latency as compared with systems in which the change log groups are flushed back to NAND memory in each iteration. Additionally, or alternatively, by utilizing hardware, such as the change log management circuitry, or some other hardware component or device, the memory system may accelerate the PPT merge process(es) and PVT generation as compared with a PPT merge and PVT generation performed by firmware or other software, which may further reduce overhead and latency.

After completing the PVT generation process, the memory system may consume and store the PVT change logs, as described in further detail elsewhere herein, including with reference to FIG. 5.

FIG. 5 shows an example of a flow diagram 500 that supports optimization for unmap backlog operations in a memory system in accordance with examples as disclosed herein. In some examples, a memory system, which may be an example of the memory systems 110 and 210 as described with reference to FIGS. 1 and 2, may implement aspects of the flow diagram 500 using a memory system controller (e.g., a memory system controllers 115 and 215).

For ease of reference, the flow diagram 500 is described with reference to the memory system 210. For example, aspects of the flow diagram 500 may be implemented by one or more controllers, such as an interface controller, among other components. Additionally or alternatively, aspects of the flow diagram 500 may be implemented as instructions stored in one or more memories (e.g., firmware stored in the volatile memory 120 and/or the non-volatile memory 125). For example, the instructions, when executed by one or more controllers (e.g., the interface controller 115), may cause the one or more controllers (or a device or a system) to perform the operations of the flow diagram 500. It is to be understood that various aspects of the flow diagram 500 may be performed by one or more various components of the memory system, including one or more memory system controllers, one or more memory device controllers, firmware, hardware, or any combination thereof.

Alternative examples of the flow diagram 500 may be implemented in which some operations are performed in a different order than described or are not performed at all. In some cases, operations may include features not mentioned below, or additional operations may be added.

The flow diagram 500 may illustrate a method to consume the PVT change logs described with reference to FIGS. 3 and 4. For example, during the unmap backlog process, after the memory system completes N iterations of the PVT generation, the memory system may perform a PVT load, merge, and flush process, as described by the flow diagram 500. The flow diagram 500 may begin after all PVT change log groups are generated and stored in the first memory device.

At 505, a current PVT chunk may be set to a minimum value. For example, the memory system may identify a first chunk of a PVT and may assign a minimum value (e.g., zero) to the first chunk. In some examples, each PVT may include multiple chunks. Additionally, or alternatively, each PVT may correspond to a respective chunk.

At 510, the current PVT chunk may be loaded from the second memory device (e.g., NAND memory) to the first memory device (e.g., MRAM). In some examples, the memory system may load a full PVT at the same time, or the memory system may load each chunk individually. In some examples, change log management circuitry of the memory system may obtain, from the second memory device, the PVT configured to indicate whether one or more pages of data stored in the first memory device are valid. For example, the memory system may load the PVT to a buffer of the change log management circuitry.

At 515, a PVT change log group index may be set to zero. The PVT change log group index may track which chunk is being merged at a given time. Accordingly, by setting the index to zero, the memory system may indicate a beginning of the PVT merge process.

At 520, it may be determined whether a chunk number of a PVT chunk that is waiting to be merged (e.g., loaded from memory) is the same as the current PVT chunk associated with the PVT change log group index. If the memory system determines that the chunk number of the waiting PVT chunk is different than the PVT change log group index, the memory system may proceed to 540, and the memory system may increment the PVT change log group index.

At 525, a current PVT change log group may be transferred to a buffer. For example, if the memory system determines that the chunk number of the waiting PVT chunk is the same as the PVT change log group index, the memory system may transfer the current PVT change log group to a PVT log buffer associated with the PVT merge. In some examples, the PVT change log group may be transferred from an MRAM buffer to the PVT log buffer of the change log management circuitry. That is, the change log management circuitry may receive, from the first memory device and at a buffer, one or more change logs configured to indicate changes to a PVT in response to an unmap process.

At 530, the PVT may be updated. Updating the PVT may include merging the PVT change log group with the PVT chunk. For each PVT chunk that is to be updated, the memory system may load the PVT to a table merge buffer in the first memory device and may activate the change log management circuitry to perform the PVT merge. In some examples, the table merge buffer and the PVT log buffer may both be associated with the change log management circuitry. The change log management circuitry may update the PVT chunk by applying any changes indicated via the PVT change log group to corresponding addresses in the PVT chunk. In some examples, the change log management circuitry may output the updated PVT after applying the PVT change log group.

At 535, after updating the PVT using the current change log group, a next chunk number of a next PVT chunk may be recorded. For example, the memory system may search for and record the next chunk number of a next PVT chunk that is waiting to be merged with the PVT change log group.

At 540, the PVT change log group index may be incremented (e.g., PVT change log group index ++). The memory system may increment the PVT change log group index after merging a current PVT change log group with the PVT, or if the memory system determines that a current PVT change log group is different than the waiting merge PVT chunk number.

At 545, it may be determined whether all PVT change log groups have been complete (e.g., merged). If the memory system determines that there are more PVT change log groups to be merged, the memory system may return to 520 to merge the remaining PVT change log groups.

At 550, the current PVT chunk may be flushed to the second memory device. For example, if the memory system determines that all of the PVT change log groups have been merged, the memory system may flush the current PVT chunk to the second memory device. That is, the memory system may flush the updated PVT chunk back to the NAND memory device. In some examples, the updated PVT chunk may be output from the change log management circuitry, and the memory system may flush the PVT chunk from the output of the change log management circuitry.

At 555, it may be determined whether all PVT chunks have been updated. For example, the memory system may scan the second memory device to determine whether any remaining PVT chunks are to be updated. If the memory system determines that there are more PVT chunks to be updated, the memory system may return to 505 to update the remaining PVT chunks. If the memory system determines that there are not any more PVT chunks to be updated, the memory system may complete the PVT consumption process. For example, the unmap backlog process may be complete.

The memory system described herein may thereby perform a PVT merge process to update a PVT using PVT change log groups stored in an MRAM buffer until all iterations of an unmap process are complete. By waiting to perform the PVT merge and flush until after the iterations are complete, the memory system may reduce overhead and latency as compared with systems in which the PVT is loaded, merged, and flushed in each iteration. Additionally, or alternatively, by utilizing hardware, such as the change log management circuitry, or some other hardware component or device, the memory system may accelerate the PVT merge process as compared with a PVT merge performed by firmware or other software, which may further reduce overhead and latency.

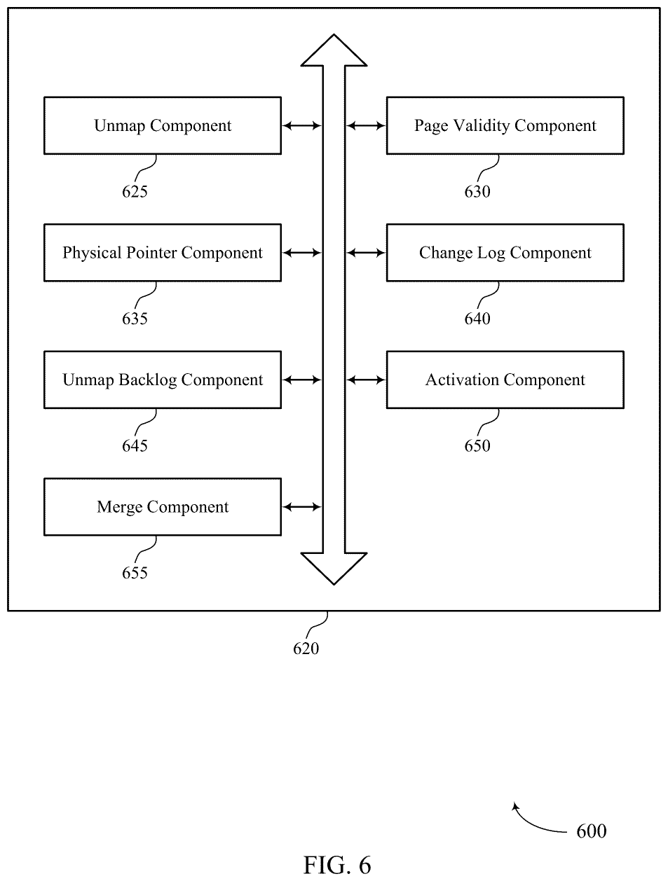

FIG. 6 shows a block diagram 600 of a memory system 620 that supports optimization for unmap backlog operations in a memory system in accordance with examples as disclosed herein. The memory system 620 may be an example of aspects of a memory system as described with reference to FIGS. 1 through 5. The memory system 620, or various components thereof, may be an example of means for performing various aspects of optimization for unmap backlog operations in a memory system as described herein. For example, the memory system 620 may include an unmap component 625, a page validity component 630, a physical pointer component 635, a change log component 640, an unmap backlog component 645, an activation component 650, a merge component 655, or any combination thereof. Each of these components, or components of subcomponents thereof (e.g., one or more processors, one or more memories), may communicate, directly or indirectly, with one another (e.g., via one or more buses).

The unmap component 625 may be configured as or otherwise support a means for performing a plurality of iterations of an unmap process for a set of data in an unmap backlog of a memory system, where the plurality of iterations of the unmap process produce a plurality of page validity change logs. In some examples, to each iteration of the plurality of iterations, the change log component 640 may be configured as or otherwise support a means for storing, in a first memory device of the memory system and based at least in part on a first physical pointer, a change log that indicates a set of entries from among a plurality of entries in a second physical pointer that have changed based at least in part on the unmap process and the page validity component 630 may be configured as or otherwise support a means for storing, in the first memory device and based at least in part on the second physical pointer, a page validity change log of the plurality of page validity change logs. The page validity component 630 may be configured as or otherwise support a means for flushing, based at least in part on completion of the plurality of iterations, one or more page validity tables from the first memory device to a second memory device of the memory system.

In some examples, the physical pointer component 635 may be configured as or otherwise support a means for flushing as part of a final iteration of the plurality of iterations of the unmap process, a plurality of second physical pointers from the first memory device to the second memory device.

In some examples, the physical pointer component 635 may be configured as or otherwise support a means for loading, from the second memory device to the first memory device, the plurality of second physical pointers. In some examples, the merge component 655 may be configured as or otherwise support a means for merging a plurality of change logs stored in the first memory device during the unmap process with the plurality of second physical pointers, where flushing the plurality of second physical pointers from the first memory device to the second memory device is based at least in part on the merging.

In some examples, to support each iteration, the page validity component 630 may be configured as or otherwise support a means for generating a plurality of entries of the page validity change log, where the page validity change log is stored based at least in part on a quantity of entries of the plurality of entries in the page validity change log exceeds a threshold. In some examples, to support each iteration, the page validity component 630 may be configured as or otherwise support a means for generating a second plurality of entries of a second page validity change log based at least in part on the quantity of entries of the plurality of entries in the page validity change log exceeding the threshold.

In some examples, the page validity component 630 may be configured as or otherwise support a means for loading, from the second memory device to the first memory device, the one or more page validity tables. In some examples, the page validity component 630 may be configured as or otherwise support a means for updating, at the first memory device, the one or more page validity tables based at least in part on the plurality of page validity change logs, where flushing the one or more page validity tables from the first memory device to the second memory device is based at least in part on updating the one or more page validity tables.

In some examples, the page validity component 630 may be configured as or otherwise support a means for transferring, based at least in part on loading the one or more page validity tables to the first memory device, the one or more page validity tables to a buffer of circuitry of the first memory device, the circuitry configured to merge the plurality of page validity change logs with the one or more page validity tables. In some examples, the activation component 650 may be configured as or otherwise support a means for activating the circuitry, where updating the one or more page validity tables is based at least in part on activating the circuitry.

In some examples, the physical pointer component 635 may be configured as or otherwise support a means for loading, from the second memory device to the first memory device, the first physical pointer. In some examples, the change log component 640 may be configured as or otherwise support a means for generating, based at least in part on the first physical pointer loaded to the first memory device, the change log that indicates the set of entries from among the plurality of entries in the second physical pointer that have changed.

In some examples, the unmap component 625 may be configured as or otherwise support a means for receiving an unmap command that indicates a plurality of memory addresses to be unmapped. In some examples, the unmap component 625 may be configured as or otherwise support a means for unmapping, based at least in part on the unmap command, a portion of memory addresses from among the plurality of memory addresses. In some examples, the unmap backlog component 645 may be configured as or otherwise support a means for storing the unmap backlog based at least in part on unmapping the portion of the memory addresses, where the unmap backlog indicates remaining memory addresses from among the plurality of memory addresses, the remaining memory addresses associated with the set of data.

In some examples, each entry of the plurality of entries in the second physical pointer corresponds to a page of entries in the first physical pointer. In some examples, each entry of the page of entries in the first physical pointer maps a respective logical address to a respective physical address in the second memory device where corresponding data is stored.

In some examples, the page validity change log indicates one or more pages of the set of data that have been unmapped as part of the unmap process.

In some examples, the first memory device includes RAM and the second memory device includes not-and (NAND) memory.

The physical pointer component 635 may be configured as or otherwise support a means for obtaining, from a first memory device of a memory system, a first physical pointer configured to map a plurality of logical addresses to a plurality of physical addresses, the first memory device configured to store data and one or more physical pointers associated with the data. The change log component 640 may be configured as or otherwise support a means for obtaining, from a second memory device of the memory system, one or more change logs configured to indicate changes to the data based at least in part on the unmap process. In some examples, the change log component 640 may be configured as or otherwise support a means for applying the one or more change logs to the first physical pointer. In some examples, the page validity component 630 may be configured as or otherwise support a means for outputting, to the first memory device based at least in part on application of the one or more change logs to the first physical pointer, a page validity change log configured to indicate one or more pages of the data that have changed based at least in part on an unmap operation.

In some examples, the change log component 640 may be configured as or otherwise support a means for generating, based at least in part on the application of the one or more change logs to the first physical pointer, one or more second change logs configured to indicate changes to a second physical pointer.

In some examples, the physical pointer component 635 may be configured as or otherwise support a means for obtaining, from the first memory device, the second physical pointer. In some examples, the change log component 640 may be configured as or otherwise support a means for applying the one or more second change logs to the second physical pointer. In some examples, the page validity component 630 may be configured as or otherwise support a means for generating the page validity change log based at least in part on the application of the one or more second change logs to the second physical pointer.

In some examples, each entry of a plurality of entries in the second physical pointer corresponds to a page of entries in the first physical pointer. In some examples, each entry of the page of entries in the first physical pointer maps a respective logical address to a respective physical address in the second memory device where corresponding data is stored.

In some examples, the page validity component 630 may be configured as or otherwise support a means for generating a plurality of entries of the page validity change log, where the page validity change log is output based at least in part on a quantity of entries of the plurality of entries in the page validity change log exceeding a threshold.

In some examples, the page validity component 630 may be configured as or otherwise support a means for generating, based at least in part on outputting the page validity change log, a plurality of second entries of a second page validity change log. In some examples, the page validity component 630 may be configured as or otherwise support a means for outputting, to the second memory device, the second page validity change log based at least in part on a quantity of entries of the plurality of second entries in the second page validity change log exceeding the threshold.

In some examples, the first physical pointer includes entries that are included in an unmap backlog of the memory system.

In some examples, the first memory device includes not-and (NAND) memory and the second memory device includes RAM.

In some examples, the page validity component 630 may be configured as or otherwise support a means for obtaining, from a first memory device of a memory system, a page validity table configured to indicate whether one or more pages of a plurality of pages of data stored in the first memory device are valid. In some examples, the change log component 640 may be configured as or otherwise support a means for receiving, from a second memory device of the memory system and at a buffer of the circuitry, a plurality of change logs configured to indicate changes to the page validity table based at least in part on an unmap process performed by the memory system. In some examples, the change log component 640 may be configured as or otherwise support a means for applying the plurality of change logs to the page validity table. In some examples, the page validity component 630 may be configured as or otherwise support a means for outputting the updated page validity table based at least in part on application of the plurality of change logs.

In some examples, to support applying the plurality of change logs to the page validity table, the page validity component 630 may be configured as or otherwise support a means for identifying one or more entries in the page validity table that have changed based at least in part on the unmap process. In some examples, to support applying the plurality of change logs to the page validity table, the page validity component 630 may be configured as or otherwise support a means for storing, in the identified one or more entries of the page validity table, changed data based at least in part on the plurality of change logs.

In some examples, the change log component 640 may be configured as or otherwise support a means for generating, based at least in part on one or more physical pointers, the plurality of change logs configured to indicate the changes to the page validity table. In some examples, the change log component 640 may be configured as or otherwise support a means for outputting the plurality of change logs to the second memory device, where receiving the plurality of change logs is based at least in part on the generation of the plurality of change logs.

In some examples, the first memory device includes not-and (NAND) memory and the second memory device includes RAM.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 620, or various components thereof, may be implemented at least in part by instructions (e.g., stored in memory, non-transitory computer-readable medium) executable by such at least one processor.

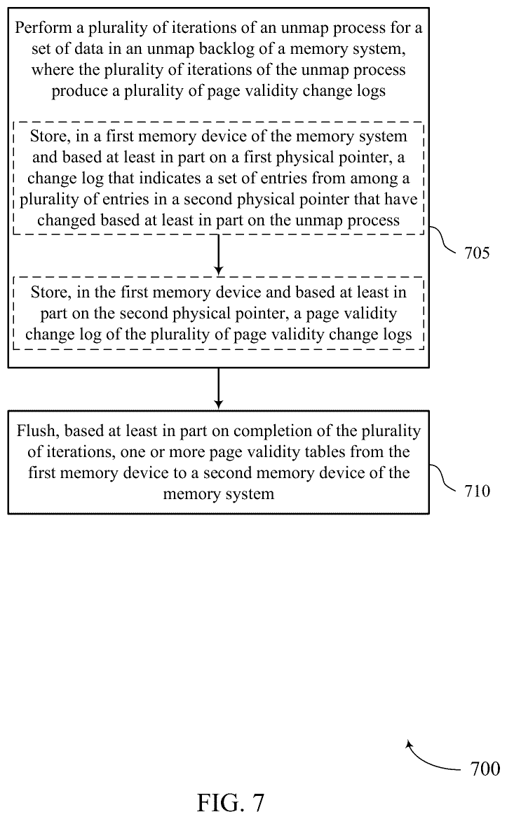

FIG. 7 shows a flowchart illustrating a method 700 that supports optimization for unmap backlog operations in a memory system in accordance with examples as disclosed herein. The operations of method 700 may be implemented by a memory system or its components as described herein. For example, the operations of method 700 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 705, the method may include performing a plurality of iterations of an unmap process for a set of data in an unmap backlog of a memory system, where the plurality of iterations of the unmap process produce a plurality of page validity change logs. In some examples, each iteration of the plurality of iterations may include storing, in a first memory device of the memory system and based at least in part on a first physical pointer, a change log that indicates a set of entries from among a plurality of entries in a second physical pointer that have changed based at least in part on the unmap process and storing, in the first memory device and based at least in part on the second physical pointer, a page validity change log of the plurality of page validity change logs. In some examples, aspects of the operations of 705 may be performed by an unmap component 625 as described with reference to FIG. 6.

At 710, the method may include flushing, based at least in part on completion of the plurality of iterations, one or more page validity tables from the first memory device to a second memory device of the memory system. In some examples, aspects of the operations of 710 may be performed by a page validity component 630 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for performing a plurality of iterations of an unmap process for a set of data in an unmap backlog of a memory system, where the plurality of iterations of the unmap process produce a plurality of page validity change logs, and where each iteration of the plurality of iterations includes storing, in a first memory device of the memory system and based at least in part on a first physical pointer, a change log that indicates a set of entries from among a plurality of entries in a second physical pointer that have changed based at least in part on the unmap process and storing, in the first memory device and based at least in part on the second physical pointer, a page validity change log of the plurality of page validity change logs and flushing, based at least in part on completion of the plurality of iterations, one or more page validity tables from the first memory device to a second memory device of the memory system.
Aspect 2: The method, apparatus, or non-transitory computer-readable medium of aspect 1, further including operations, features, circuitry, logic, means, or instructions, or any combination thereof for flushing as part of a final iteration of the plurality of iterations of the unmap process, a plurality of second physical pointers from the first memory device to the second memory device.
Aspect 3: The method, apparatus, or non-transitory computer-readable medium of aspect 2, further including operations, features, circuitry, logic, means, or instructions, or any combination thereof for loading, from the second memory device to the first memory device, the plurality of second physical pointers and merging a plurality of change logs stored in the first memory device during the unmap process with the plurality of second physical pointers, where flushing the plurality of second physical pointers from the first memory device to the second memory device is based at least in part on the merging.
Aspect 4: The method, apparatus, or non-transitory computer-readable medium of any of aspects 1 through 3, where each iteration further includes operations, features, circuitry, logic, means, or instructions, or any combination thereof for generating a plurality of entries of the page validity change log, where the page validity change log is stored based at least in part on a quantity of entries of the plurality of entries in the page validity change log exceeds a threshold and generating a second plurality of entries of a second page validity change log based at least in part on the quantity of entries of the plurality of entries in the page validity change log exceeding the threshold.
Aspect 5: The method, apparatus, or non-transitory computer-readable medium of any of aspects 1 through 4, further including operations, features, circuitry, logic, means, or instructions, or any combination thereof for loading, from the second memory device to the first memory device, the one or more page validity tables and updating, at the first memory device, the one or more page validity tables based at least in part on the plurality of page validity change logs, where flushing the one or more page validity tables from the first memory device to the second memory device is based at least in part on updating the one or more page validity tables.
Aspect 6: The method, apparatus, or non-transitory computer-readable medium of aspect 5, further including operations, features, circuitry, logic, means, or instructions, or any combination thereof for transferring, based at least in part on loading the one or more page validity tables to the first memory device, the one or more page validity tables to a buffer of circuitry of the first memory device, the circuitry configured to merge the plurality of page validity change logs with the one or more page validity tables and activating the circuitry, where updating the one or more page validity tables is based at least in part on activating the circuitry.
Aspect 7: The method, apparatus, or non-transitory computer-readable medium of any of aspects 1 through 6, further including operations, features, circuitry, logic, means, or instructions, or any combination thereof for loading, from the second memory device to the first memory device, the first physical pointer and generating, based at least in part on the first physical pointer loaded to the first memory device, the change log that indicates the set of entries from among the plurality of entries in the second physical pointer that have changed.
Aspect 8: The method, apparatus, or non-transitory computer-readable medium of any of aspects 1 through 7, further including operations, features, circuitry, logic, means, or instructions, or any combination thereof for receiving an unmap command that indicates a plurality of memory addresses to be unmapped; unmapping, based at least in part on the unmap command, a portion of memory addresses from among the plurality of memory addresses; and storing the unmap backlog based at least in part on unmapping the portion of the memory addresses, where the unmap backlog indicates remaining memory addresses from among the plurality of memory addresses, the remaining memory addresses associated with the set of data.
Aspect 9: The method, apparatus, or non-transitory computer-readable medium of any of aspects 1 through 8, where each entry of the plurality of entries in the second physical pointer corresponds to a page of entries in the first physical pointer and each entry of the page of entries in the first physical pointer maps a respective logical address to a respective physical address in the second memory device where corresponding data is stored.
Aspect 10: The method, apparatus, or non-transitory computer-readable medium of any of aspects 1 through 9, where the page validity change log indicates one or more pages of the set of data that have been unmapped as part of the unmap process.
Aspect 11: The method, apparatus, or non-transitory computer-readable medium of any of aspects 1 through 10, where the first memory device includes RAM and the second memory device includes not-and (NAND) memory.

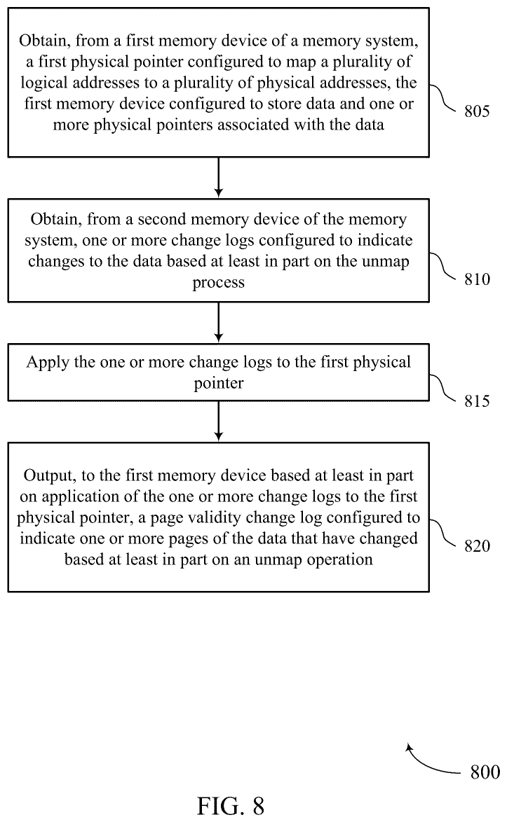

FIG. 8 shows a flowchart illustrating a method 800 that supports optimization for unmap backlog operations in a memory system in accordance with examples as disclosed herein. The operations of method 800 may be implemented by a memory system or its components as described herein. For example, the operations of method 800 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 805, the method may include obtaining, from a first memory device of a memory system, a first physical pointer configured to map a plurality of logical addresses to a plurality of physical addresses, the first memory device configured to store data and one or more physical pointers associated with the data. In some examples, aspects of the operations of 805 may be performed by a physical pointer component 635 as described with reference to FIG. 6.

At 810, the method may include obtaining, from a second memory device of the memory system, one or more change logs configured to indicate changes to the data based at least in part on the unmap process. In some examples, aspects of the operations of 810 may be performed by a change log component 640 as described with reference to FIG. 6.

At 815, the method may include applying the one or more change logs to the first physical pointer. In some examples, aspects of the operations of 815 may be performed by a change log component 640 as described with reference to FIG. 6.

At 820, the method may include outputting, to the first memory device based at least in part on application of the one or more change logs to the first physical pointer, a page validity change log configured to indicate one or more pages of the data that have changed based at least in part on an unmap operation. In some examples, aspects of the operations of 820 may be performed by a page validity component 630 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 12: A method, apparatus, or non-transitory computer-readable medium including operations, features, circuitry, logic, means, or instructions, or any combination thereof for obtaining, from a first memory device of a memory system, a first physical pointer configured to map a plurality of logical addresses to a plurality of physical addresses, the first memory device configured to store data and one or more physical pointers associated with the data; obtaining, from a second memory device of the memory system, one or more change logs configured to indicate changes to the data based at least in part on the unmap process; applying the one or more change logs to the first physical pointer; and outputting, to the first memory device based at least in part on application of the one or more change logs to the first physical pointer, a page validity change log configured to indicate one or more pages of the data that have changed based at least in part on an unmap operation.
Aspect 13: The method, apparatus, or non-transitory computer-readable medium of aspect 12, further including operations, features, circuitry, logic, means, or instructions, or any combination thereof for generating, based at least in part on the application of the one or more change logs to the first physical pointer, one or more second change logs configured to indicate changes to a second physical pointer.
Aspect 14: The method, apparatus, or non-transitory computer-readable medium of aspect 13, further including operations, features, circuitry, logic, means, or instructions, or any combination thereof for obtaining, from the first memory device, the second physical pointer; applying the one or more second change logs to the second physical pointer; and generating the page validity change log based at least in part on the application of the one or more second change logs to the second physical pointer.
Aspect 15: The method, apparatus, or non-transitory computer-readable medium of any of aspects 13 through 14, where each entry of a plurality of entries in the second physical pointer corresponds to a page of entries in the first physical pointer and each entry of the page of entries in the first physical pointer maps a respective logical address to a respective physical address in the second memory device where corresponding data is stored.
Aspect 16: The method, apparatus, or non-transitory computer-readable medium of any of aspects 12 through 15, further including operations, features, circuitry, logic, means, or instructions, or any combination thereof for generating a plurality of entries of the page validity change log, where the page validity change log is output based at least in part on a quantity of entries of the plurality of entries in the page validity change log exceeding a threshold.
Aspect 17: The method, apparatus, or non-transitory computer-readable medium of aspect 16, further including operations, features, circuitry, logic, means, or instructions, or any combination thereof for generating, based at least in part on outputting the page validity change log, a plurality of second entries of a second page validity change log and outputting, to the second memory device, the second page validity change log based at least in part on a quantity of entries of the plurality of second entries in the second page validity change log exceeding the threshold.
Aspect 18: The method, apparatus, or non-transitory computer-readable medium of any of aspects 12 through 17, where the first physical pointer includes entries that are included in an unmap backlog of the memory system.
Aspect 19: The method, apparatus, or non-transitory computer-readable medium of any of aspects 12 through 18, where the first memory device includes not-and (NAND) memory and the second memory device includes RAM.

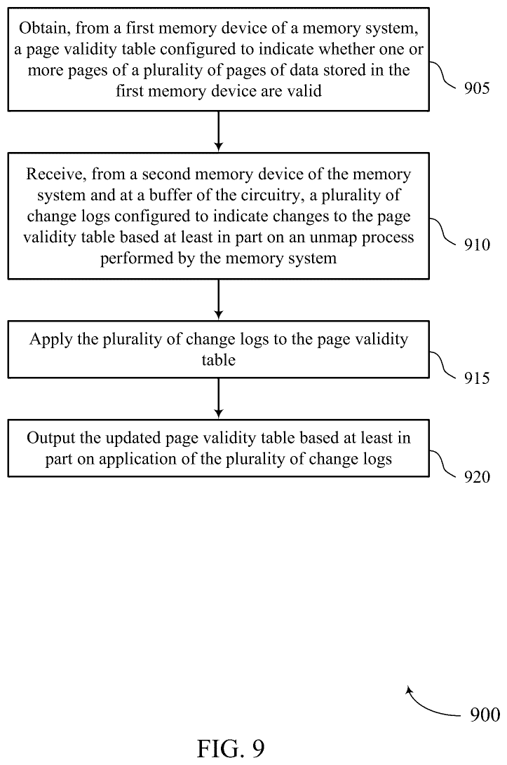

FIG. 9 shows a flowchart illustrating a method 900 that supports optimization for unmap backlog operations in a memory system in accordance with examples as disclosed herein. The operations of method 900 may be implemented by a memory system or its components as described herein. For example, the operations of method 900 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 905, the method may include obtaining, from a first memory device of a memory system, a page validity table configured to indicate whether one or more pages of a plurality of pages of data stored in the first memory device are valid. In some examples, aspects of the operations of 905 may be performed by a page validity component 630 as described with reference to FIG. 6.

At 910, the method may include receiving, from a second memory device of the memory system and at a buffer of the circuitry, a plurality of change logs configured to indicate changes to the page validity table based at least in part on an unmap process performed by the memory system. In some examples, aspects of the operations of 910 may be performed by a change log component 640 as described with reference to FIG. 6.

At 915, the method may include applying the plurality of change logs to the page validity table. In some examples, aspects of the operations of 915 may be performed by a change log component 640 as described with reference to FIG. 6.

At 920, the method may include outputting the updated page validity table based at least in part on application of the plurality of change logs. In some examples, aspects of the operations of 920 may be performed by a page validity component 630 as described with reference to FIG. 6.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:
Aspect 20: A method, apparatus, or non-transitory computer-readable medium including operations, features, circuitry, logic, means, or instructions, or any combination thereof for obtaining, from a first memory device of a memory system, a page validity table configured to indicate whether one or more pages of a plurality of pages of data stored in the first memory device are valid; receiving, from a second memory device of the memory system and at a buffer of the circuitry, a plurality of change logs configured to indicate changes to the page validity table based at least in part on an unmap process performed by the memory system; applying the plurality of change logs to the page validity table; and outputting the updated page validity table based at least in part on application of the plurality of change logs.
Aspect 21: The method, apparatus, or non-transitory computer-readable medium of aspect 20, where applying the plurality of change logs to the page validity table further includes operations, features, circuitry, logic, means, or instructions, or any combination thereof for identifying one or more entries in the page validity table that have changed based at least in part on the unmap process and storing, in the identified one or more entries of the page validity table, changed data based at least in part on the plurality of change logs.
Aspect 22: The method, apparatus, or non-transitory computer-readable medium of any of aspects 20 through 21, further including operations, features, circuitry, logic, means, or instructions, or any combination thereof for generating, based at least in part on one or more physical pointers, the plurality of change logs configured to indicate the changes to the page validity table and outputting the plurality of change logs to the second memory device, where receiving the plurality of change logs is based at least in part on the generation of the plurality of change logs.
Aspect 23: The method, apparatus, or non-transitory computer-readable medium of any of aspects 20 through 22, where the first memory device includes not-and (NAND) memory and the second memory device includes RAM.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
perform a plurality of iterations of an unmap process for a set of data in an unmap backlog of a memory system, wherein the plurality of iterations of the unmap process produce a plurality of page validity change logs, and wherein each iteration of the plurality of iterations comprises the processing circuitry configured to cause the memory system to:
store, in a first memory device of the memory system and based at least in part on a first physical pointer, a change log that indicates a set of entries from among a plurality of entries in a second physical pointer that have changed based at least in part on the unmap process; and
store, in the first memory device and based at least in part on the second physical pointer, a page validity change log of the plurality of page validity change logs; and
flush, based at least in part on completion of the plurality of iterations, one or more page validity tables from the first memory device to a second memory device of the memory system.

2. The memory system of claim 1, wherein the processing circuitry is further configured to cause the memory system to:
flush as part of a final iteration of the plurality of iterations of the unmap process, a plurality of second physical pointers from the first memory device to the second memory device.

3. The memory system of claim 2, wherein the processing circuitry is further configured to cause the memory system to:
load, from the second memory device to the first memory device, the plurality of second physical pointers; and
merge a plurality of change logs stored in the first memory device during the unmap process with the plurality of second physical pointers, wherein flushing the plurality of second physical pointers from the first memory device to the second memory device is based at least in part on the merging.

4. The memory system of claim 1, wherein each iteration further comprises the processing circuitry configured to cause the memory system to:
generate a plurality of entries of the page validity change log, wherein the page validity change log is stored based at least in part on a quantity of entries of the plurality of entries in the page validity change log exceeds a threshold; and
generate a second plurality of entries of a second page validity change log based at least in part on the quantity of entries of the plurality of entries in the page validity change log exceeding the threshold.

5. The memory system of claim 1, wherein the processing circuitry is further configured to cause the memory system to:
load, from the second memory device to the first memory device, the one or more page validity tables; and
update, at the first memory device, the one or more page validity tables based at least in part on the plurality of page validity change logs, wherein flushing the one or more page validity tables from the first memory device to the second memory device is based at least in part on updating the one or more page validity tables.

6. The memory system of claim 5, wherein the processing circuitry is further configured to cause the memory system to:
transfer, based at least in part on loading the one or more page validity tables to the first memory device, the one or more page validity tables to a buffer of circuitry of the first memory device, the circuitry configured to merge the plurality of page validity change logs with the one or more page validity tables; and
activate the circuitry, wherein updating the one or more page validity tables is based at least in part on activating the circuitry.

7. The memory system of claim 1, wherein the processing circuitry is further configured to cause the memory system to:
load, from the second memory device to the first memory device, the first physical pointer; and
generate, based at least in part on the first physical pointer loaded to the first memory device, the change log that indicates the set of entries from among the plurality of entries in the second physical pointer that have changed.

8. The memory system of claim 1, wherein the processing circuitry is further configured to cause the memory system to:
receive an unmap command that indicates a plurality of memory addresses to be unmapped;
unmap, based at least in part on the unmap command, a portion of memory addresses from among the plurality of memory addresses; and
store the unmap backlog based at least in part on unmapping the portion of the memory addresses, wherein the unmap backlog indicates remaining memory addresses from among the plurality of memory addresses, the remaining memory addresses associated with the set of data.

9. The memory system of claim 1, wherein:
each entry of the plurality of entries in the second physical pointer corresponds to a page of entries in the first physical pointer; and
each entry of the page of entries in the first physical pointer maps a respective logical address to a respective physical address in the second memory device where corresponding data is stored.

10. The memory system of claim 1, wherein the page validity change log indicates one or more pages of the set of data that have been unmapped as part of the unmap process.

11. The memory system of claim 1, wherein the first memory device comprises random access memory (RAM) and the second memory device comprises not-and (NAND) memory.

12. A memory system, comprising:
a first memory device configured to store data and one or more physical pointer tables associated with the data;
a second memory device configured to store one or more change logs configured to indicate changes to the data based at least in part on an unmap process; and
circuitry coupled with the first memory device and the second memory device, and configured to cause the memory system to:
obtain, from the first memory device, a first physical pointer configured to map a plurality of logical addresses to a plurality of physical addresses;
obtain, from the second memory device, the one or more change logs configured to indicate the changes to the data based at least in part on the unmap process;
apply the one or more change logs to the first physical pointer; and
output, to the first memory device based at least in part on application of the one or more change logs to the first physical pointer, a page validity change log configured to indicate one or more pages of the data that have changed based at least in part on an unmap operation.

13. The memory system of claim 12, wherein the circuitry is further configured to cause the memory system to:
generate, based at least in part on the application of the one or more change logs to the first physical pointer, one or more second change logs configured to indicate changes to a second physical pointer.

14. The memory system of claim 13, wherein the circuitry is further configured to cause the memory system to:
obtain, from the first memory device, the second physical pointer;
apply the one or more second change logs to the second physical pointer; and
generate the page validity change log based at least in part on the application of the one or more second change logs to the second physical pointer.

15. The memory system of claim 13, wherein:
each entry of a plurality of entries in the second physical pointer corresponds to a page of entries in the first physical pointer; and
each entry of the page of entries in the first physical pointer maps a respective logical address to a respective physical address in the second memory device where corresponding data is stored.

16. The memory system of claim 12, wherein the circuitry is further configured to cause the memory system to:
generate a plurality of entries of the page validity change log, wherein the page validity change log is output based at least in part on a quantity of entries of the plurality of entries in the page validity change log exceeding a threshold.

17. The memory system of claim 16, wherein the circuitry is further configured to cause the memory system to:
generate, based at least in part on outputting the page validity change log, a plurality of second entries of a second page validity change log; and
output, to the second memory device, the second page validity change log based at least in part on a quantity of entries of the plurality of second entries in the second page validity change log exceeding the threshold.

18. The memory system of claim 12, wherein the first physical pointer comprises entries that are included in an unmap backlog of the memory system.

19. The memory system of claim 12, wherein the first memory device comprises not-and (NAND) memory and the second memory device comprises random access memory (RAM).

20. A memory system, comprising:
a first memory device configured to store data and one or more physical pointer tables associated with the data;
a second memory device configured to store one or more change logs configured to indicate changes to the data based at least in part on access operations; and
circuitry coupled with the first memory device and the second memory device, and configured to cause the memory system to:
obtain, from the first memory device, a page validity table configured to indicate whether one or more pages of a plurality of pages of data stored in the first memory device are valid;
receive, from the second memory device and at a buffer of the circuitry, a plurality of change logs configured to indicate changes to the page validity table based at least in part on an unmap process performed by the memory system;
apply the plurality of change logs to the page validity table; and
output the updated page validity table based at least in part on application of the plurality of change logs.

21. The memory system of claim 20, wherein, to apply the plurality of change logs to the page validity table, the circuitry is further configured to cause the memory system to:
identify one or more entries in the page validity table that have changed based at least in part on the unmap process; and
store, in the identified one or more entries of the page validity table, changed data based at least in part on the plurality of change logs.

22. The memory system of claim 20, wherein the circuitry is further configured to cause the memory system to:
generate, based at least in part on one or more physical pointers, the plurality of change logs configured to indicate the changes to the page validity table; and
output the plurality of change logs to the second memory device, wherein receiving the plurality of change logs is based at least in part on the generation of the plurality of change logs.

23. The memory system of claim 20, wherein the first memory device comprises not-and (NAND) memory and the second memory device comprises random access memory (RAM).
